(19) United States
(12) Patent Application Publication
(10) Pub. No.: US 2007/0230606 A1
(43) Pub. Date: Oct. 4, 2007

(54) Viterbi traceback

(76) Inventors: Mark A. Anders, Hillsboro, OR (US); Ram K. Krishnamurthy, Portland, OR (US); Sanu K. Mathew, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/395,108

(22) Filed: Mar. 31, 2006

(51) Int. Cl. H04L 23/02

(52) U.S. Cl. 375/262

(57) ABSTRACT

In accordance with some embodiments, a traceback unit with traceback and path memories is provided.

### BACKGROUND

Digital signal processing algorithms in communication systems can be complicated and computationally intensive. As performance demands increase, it is becoming ever more difficult to implement circuits for efficiently performing such algorithms. The Viterbi algorithm is an example of such an algorithm. It may be used to encode/decode a bit stream to be transmitted over a “noisy” channel such as with many wireless environments. While conventional circuits to implement Viterbi decoding are adequate in many cases, improved solutions are desired.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of a conventional communications link utilizing a Viterbi encoding/decoding scheme.

FIG. 2 is a diagram of an exemplary Viterbi path trellis.

FIG. 3 is a schematic block diagram m of a conventional traceback unit.

FIG. 4 is a block diagram of a communications link using a Viterbi encoding/decoding scheme with a novel traceback unit.

FIG. 5 is a schematic block diagram of a novel traceback unit in accordance with same embodiments.

FIG. 6 is a schematic diagram of a register file bit cell, which may be used for the traceback unit of FIG. 5.

FIG. 7 is a block diagram of a computer with a wireless Viterbi communications link in accordance with some embodiments disclosed herein.

### DETAILED DESCRIPTION

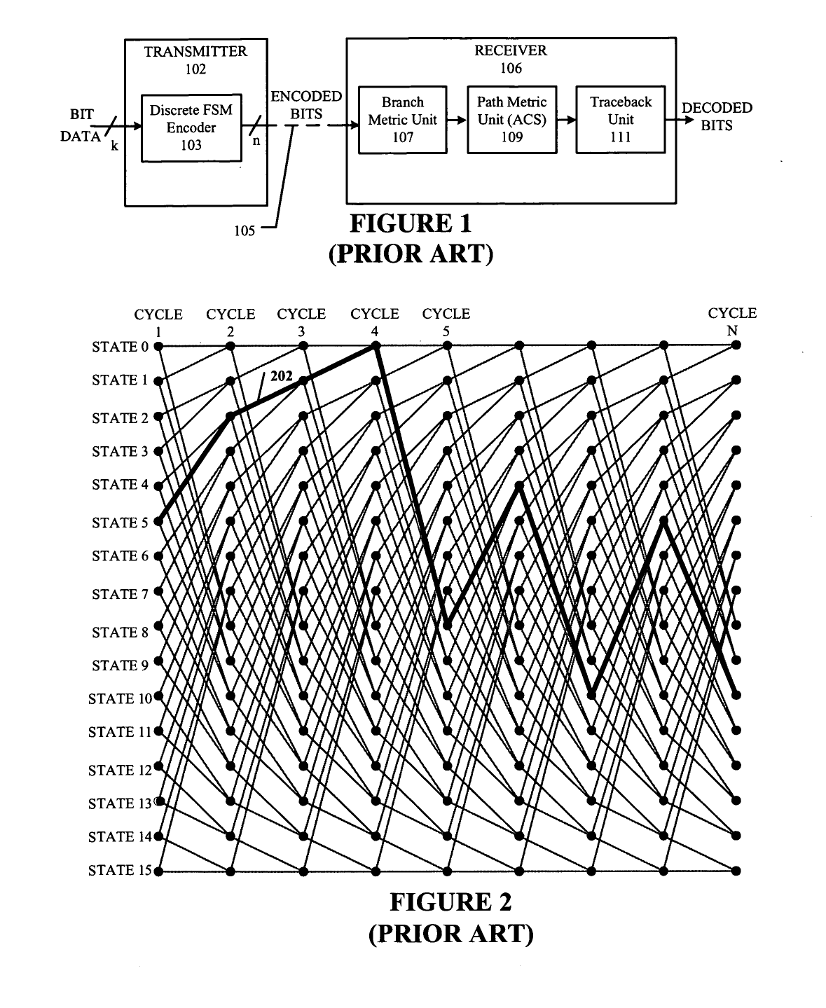

FIG. 1 shows a conventional communications link implementing a Viterbi encoding methodology. It includes a transmitter 102 to transmit encoded data over a channel 105 (e.g., wireless channel) to a receiver 106 to provide at its output the decoded data bits. The transmitter 102 comprises an N-stage discrete finite-state-machine (FSM) encoder having an associated rate of k/n to encode each incoming bit into an n-bit symbol. For example, encoder 103 could have 4 stages resulting in 16 (i.e., 2^{N}) possible different encoding states, and it could have an associated rate of k=1, n=2 (radix 2), meaning that each input bit would be encoded into a 2-bit symbol to be transmitted over the channel 105.

The decoder 106 decodes the received symbol data, in essence, by “forcing” the observed (received) symbol sequence into a sequence that could have been generated by the finite-state machine encoder and that results from the least amount of forcing. To do this, it computes a path trellis such as the trellis of FIG. 2. A path trellis comprises an X by Y matrix of state nodes, one for each state (row parameter) at each cycle (column parameter) for a sufficient number of cycles. Each cycle corresponds to a newly received symbol. The trellis indicates the possible state transitions from cycle to cycle. There are a finite number of transition options (branches) from each state to particular states in the next cycle. With the trellis of FIG. 2 (which corresponds to a 16 state, radix 2 encoding scheme), there are 2 branch options from each state to states in the next cycle. The transition branches each have an associated symbol value (e.g., '00, '01, '10, '11). Thus, the trellis can be used to map an incoming symbol sequence against a valid sequence that could have been generated by the FSM encoder.

The decoder 106 comprises a branch metrics unit 107, a path metrics unit 109, and a traceback unit 111. The branch metrics unit (BMU) 107 computes the branch metrics for each possible transition (branch selection) in the trellis for a given received symbol. A branch metric is the difference between a branch's symbol value and the actual received symbol value. The path (highlighted in the figure at 202, for example) through the trellis is then determined by selecting the transition which provides the minimum accumulated difference between observed symbol values and the symbol values for the selected branches upon entering each next state. To do this, the path metric unit 109 performs an add-compare-select (ACS) operation on each received symbol for each state in the trellis. The add component operation adds the current branch metric of each transition to the accumulated path metric from the previous state in the path. The compare component then computes the possible path metrics for each next state. Finally the select component chooses the minimum path metric transition, or survivor, as the correct path metric for the next state, and discards those path metrics with higher accumulated errors.

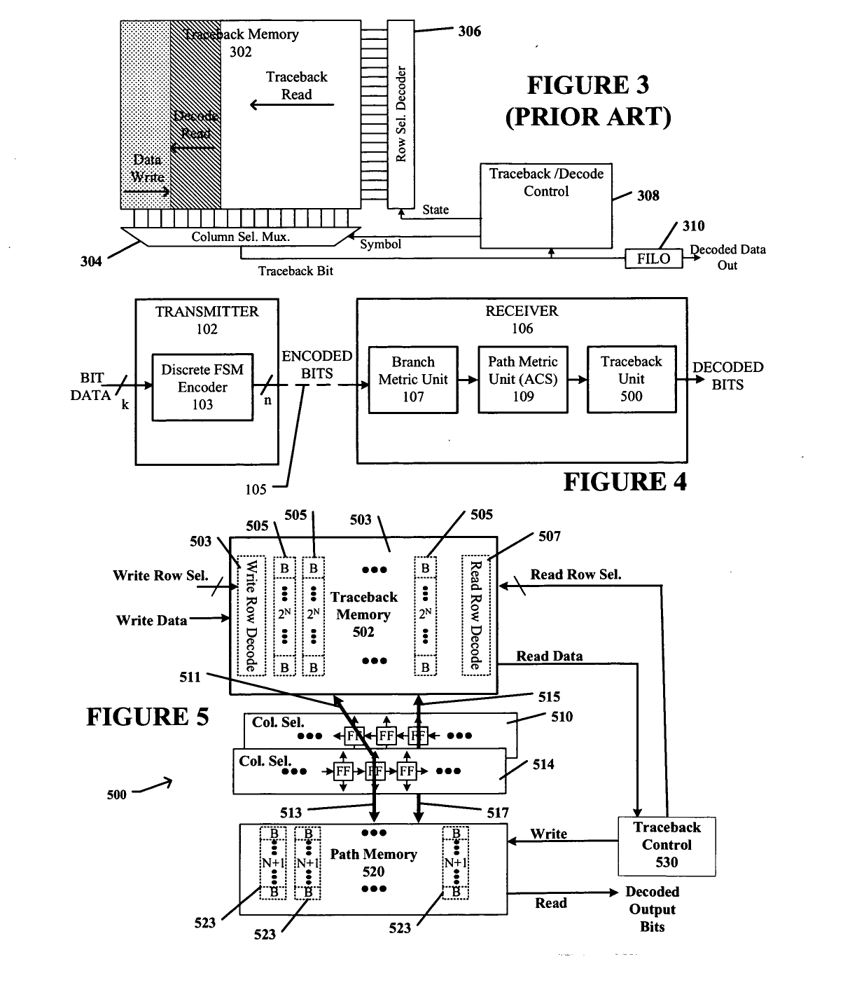

The path metrics unit 109 stores the survivor path information in a memory (e.g., traceback memory 302 in FIG. 3). For each cycle, it stores state value information for various different states corresponding to different allowable forward paths. The stored state value information indicates a path's previous state, as well as bit information for the sequence to be decoded. With this radix 2 example, a single bit can be used for each state value. Thus, with this example, if a trellis with a width of 150 cycles is used, a memory comprising a 16 by 150 bit cell array could be used to store state transition (path) information with each row corresponding to a different one of the sixteen states, and the stored bit value for a given row/column combination corresponding to state value information for a given state for a given cycle.

The traceback unit 111 determines the correct output bit sequence by following the survivor transitions in the reverse direction, using the saved information from the ACS operations indicating which path was the survivor. The further back the transition path is traced, the greater the likelihood that the paths from all the final states lead to the same transition resulting in the lowest error. For example, in some commonly used systems, tracing back in excess of 50 cycles provides a sufficient likelihood that convergence to the correct path will occur. The traceback and decode operation thus comprises following backwards (e.g., right-to-left) the transition path starting in any of the states through a sufficient number of states such that it is likely that all states would have led to the same “correct” branch. At this point, the maximum likelihood input sequence is known and can be placed in the proper order and made available as the decoded bit data. The decode operation proceeds until it reaches the beginning of the symbols or the location where the previous decode operation ended.

With reference to FIG. 3, a block diagram of a conventional traceback unit to perform these operations is shown. It includes a traceback memory 302, a column select multiplexer 304, a row select decoder 306, a traceback/decode control unit 308, and a first-in-last-out (FILO) buffer 310 to provide the decoded output data in the proper order. The traceback memory 302 serves as a ring memory buffer to implement path generation (write), traceback (read) and decode (read) operations in the indicated directions. It comprises a register file array of bit storage cells mapping to the states in the trellis for a sufficient number of cycles.

The traceback/decode control unit 308 controls traceback and decode read operations, indicated with different shading. It is coupled to the traceback memory 302 through the column select multiplexer 304 and row select decoder 306 to read a bit value from a particular bit cell, whether for traceback or decode. (Connections and control for the indicated forward-path write operation are not shown but could be implemented by the path metrics unit 109.)

Once traceback (reverse tracing) through the memory has proceeded back a sufficient number of cycles, the decode operation takes over outputting the decoded bits and storing them in the FILO buffer 310. When the decode operation is finished, the bits are then read out from the FILO buffer in the reverse order to provide them in the proper order. This continues “about” (right-to-left direction) the traceback memory as new forward path data is continually written about the memory in the opposite direction (left-to-right). Unfortunately, these circuits can be complicated due, for example, to the need to control when the decode begins and ends. Also, the output from the decoder may have to be inefficiently provided in bursts as each decode block is finished and ready for output. Additionally, the decode operation may have to share with the traceback operation by either increasing the number of traceback memory read ports (thus increasing memory size) or possibly having to share the same read port (using it at different times, decreasing traceback performance and possibly requiring increased memory size).

FIG. 4 shows a block diagram of a communications link using novel Viterbi encoding/decoding circuitry. It may comprise a transmitter 102 and receiver 106, as previously discussed, except that it also comprises a novel traceback unit 500, embodiments of which are discussed below.

FIG. 5 shows a schematic block diagram of a traceback unit 500 in accordance with some embodiments. It comprises a traceback memory 502, column select circuits 510, 514, path memory 520, and traceback control circuitry 530. The traceback memory 502 comprises an X by Y array of bit cells disposed into Y columns 505 each having 2^{N} (or X) bit cells (“B”), where N is the number of stages in the FSM encoder resulting in 2^{N} different states. The array of bit cells (“B”) has row and column select functionality for both read and write operations, which allows for a single bit to be written to or read from. Also included is a write row decoder 503 to activate a particular row of bit cells for a write operation (e.g., controlled by a path metrics unit to write forward path data into the traceback memory 502), and a read row decoder 507 to activate a row of bit cells for a read operation controlled by the traceback control circuit 530.

Similarly, the path memory comprises at least an N+1 by Y array of bit cells (B) to store state identifier and state value information for a trace-backed path from traceback memory 502. In the depicted embodiment, each bit cell column 523 includes N+1 bit cells, e.g., to store an N bit state identifier and a 1-bit state value for each cycle. For example, with the 16 state (N=4), radix 2 example, 4 bits can be used to store the state identifier and 1 bit can be used for the state value. (Note, that a path memory could, for example, comprise a larger array for more flexibility such as to accommodate FSM schemes with a larger number of states and or conversion rates. For example, a radix 4, 8-stage encoding scheme would require 8 bits to identify a state and 2 bits to indicate a 2-bit radix-4 state value.)

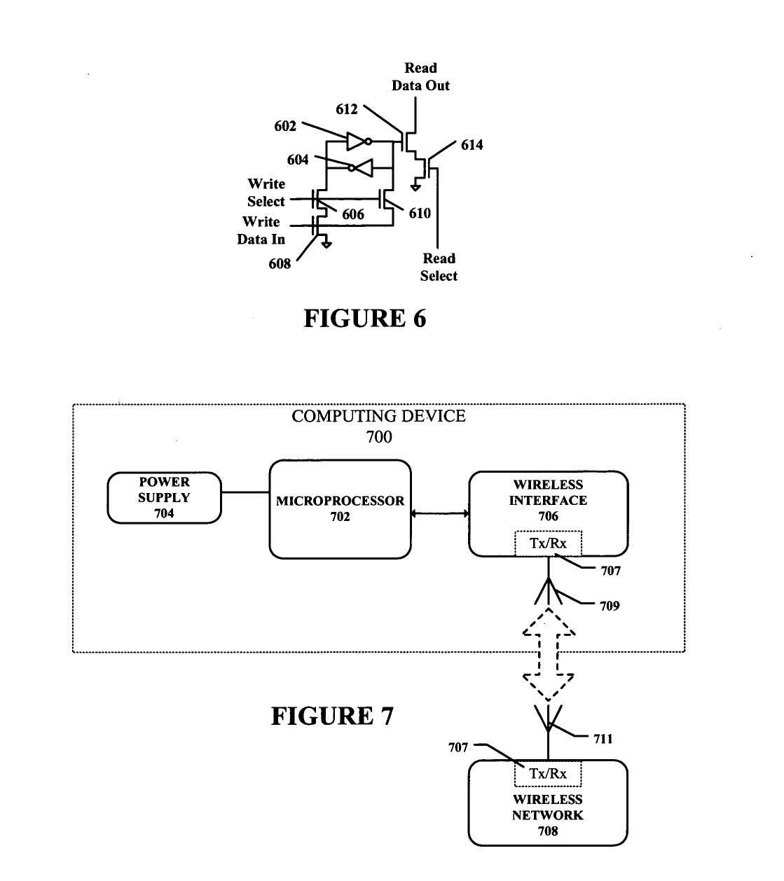

The depicted path memory 520 has column selectability for selection of a particular column of bit cells to be wholly written-to or read-from. It is coupled to the column select circuits (510, 514, discussed below) for column selection. While any suitable bit cell circuit could be used to implement the bit cells for the traceback and path memories, bit cell of FIG. 6 could be used to implement bit cells for either or both memories.

The column select circuits 510, 514 are coupled to column select lines on both the traceback memory 502 and path memory 520. Column select circuit 510 provides linked pointers (column select signals) 515 and 517. Pointer 515 serves to select a traceback memory column for a trace-backed read operation, while pointer 517 serves to select the corresponding column in the path memory 520 to write data into the path memory. Similarly, column select circuit 514 provides linked pointers 511 and 513. Pointer 511 serves to select a column in the traceback memory 502 for a forward path write operation, while pointer 513 serves to enable the corresponding column in the path memory, offset ahead by one column, for a decode read operation. The term “linked” refers to pointers being concurrently enabled. They may (as is the case with depicted linked pointer pairs 515/517 and 511/513) be generated from the same flip-flop (or equivalent circuitry), or they could be generated by different circuits. Note that pointers 511 and 513, while generated from the same flip-flop in the depicted embodiment, are coupled so that pointer 511 is offset one column behind pointer 513.

Each column select circuit (510, 514) comprises at least Y (number of columns in traceback or path memories) flip-flop circuits (FF) cascaded together in a domino-like ring configuration to cyclically generate the column select pointers when driven by a clock signal. As indicated, pointers 515, 517 (traceback pointers) travel in a counter-clockwise (right to left) direction, while pointers 511, 513 (forward path write pointers) travel in the opposite (clockwise) direction. In some embodiments, to handle the wrap-around, for each column select circuit, the flip-flop at the end is duplicated on the other end. Because traceback can occur at a faster rate than forward path write or decode operations, column select circuit 510 is typically clocked at a much faster (e.g., 16 or 32 times faster) rate than column select circuit 514.

The traceback control circuitry 530 controls traceback read operations, using pointer 515, from traceback memory 502 and the writing of trace-backed state identifier and value information, using linked pointer 517, into path memory 520. For the path memory write operation, the traceback memory row address (state identifier) going to the traceback memory and the bit read from the traceback bit cell, together as a whole word, are written into the selected path memory column. With pointers 515 and 517 being linked (and thus traveling together at the same rate), the traceback control circuitry 530 should be configured to perform these read and write operations in time before the pointers (515, 517) move to the next column.

The traceback control circuitry 530 also controls decode read operations out of the path memory 520. Because decode can generally occur at the same rate as forward path writing, commonly linked (albeit offset) pointers 511, 513 can be used for these operations. In some embodiments, the traceback control circuit 530 performs appropriate logical operations (e.g., XOR) on the state identifier and value bits read from the path memory columns in suitable combinations (in accordance with the applicable standard) in order to obtain the decoded bits.

In operation, as traceback progresses, read state data (read state values and known state identifier data) are stored in the path memory 520. This allows decode (which follows after sufficient traceback) to operate in the forward direction (instead of reverse direction as is typically the case with prior art schemes) since it can construct the decoded output bits requiring only information stored in the path memory 520. Note that because the decode operation moves in the forward direction at the same rate as the data written to the traceback memory, it does not require a separate read column select circuit. In addition, a LIFO buffer (or the like) is not required to place the decoded data into the proper order. Furthermore, only one read port is needed in the traceback memory with efficient operation still being maintained.

With the traceback pointers (515, 517) cycling at a significantly faster rate than the write/decode pointers (511, 513), traceback read (from traceback memory) and write (into path memory) will typically repeat themselves (same data read/written) while the forward path write/decode operations methodically proceed along. Thus, to reduce power consumption, in some embodiments, traceback write operations (state values and/or identifiers written into path memory) may temporarily be suspended when it is determined that the same data is being read/written until new data from traceback read is encountered.

Stated another way, the use of the path memory allows for detection of when the current traceback operation has led to the same “correct” branch as the previous pass through the memory. Detection of this may be accomplished by reading the path memory column selected by the traceback pointer when a decode read at the decode pointer is not being performed, and comparing the read column to the column value that is to be written there for the normal path memory write operation. If the values match, then future tracing will be identical to the previous trace. This lasts until the traceback pointer passes the write/decode pointer indicating that a new traceback is to begin. When this match occurs, the traceback operation can be controlled to enter a “replay” mode where traceback memory reads and path memory writes can be disabled until the pointers once again pass each other.

In some embodiments, to implement this replay mode, the traceback column select flip-flops can be changed so that instead of a single '1 (active pointer) moving through the chain, upon entry of the replay mode, a flip-flop (next to the active flip-flop when the pointers passed) is activated next to the already activated flip-flop so that traceback pointer 515 becomes two adjacent pointers (e.g., 1s). The drivers clocking the traceback column select circuit can then be disabled when two adjacent flip-flops have been activated so that the two adjacent pointers are fixed. When the write/decode pointers pass the fixed traceback pointers, the two ‘1’s change back to a single '1, and the traceback clocking is once again enabled. In other embodiments, the traceback control circuit 530 could keep track of where the pointers are and when traceback should restart, but in some schemes, that could be less efficient.

With reference to FIG. 7, one example of a computing device 700 (e.g., laptop computer, desktop computer, hand-held device, etc.) coupled to a wireless network 708 is shown. It generally comprises a processor 702 coupled to a power supply 704 and to a wireless interface 706 to couple it to the wireless network 708. (Other components such as memory, chip set and the like may be included but are not shown for simplicity.) Microprocessor 702 is coupled to the power supply 704 to receive from it power when in operation. The wireless interface 706 includes transmitter/receiver circuitry 707, which is coupled to antenna 709 to establish a wireless link between the network interface 706 and wireless network 708, which also has transmitter/receiver circuitry 707 coupled to its own antenna 711 for the wireless link. Transmitter/receiver circuits 707 utilize Viterbi encoding/decoding schemes and incorporate a traceback unit in accordance with a novel traceback unit disclosed herein.

It should be noted that the depicted system could be implemented in different forms. That is, it could be implemented in a single chip module, a circuit board, or a chassis having multiple circuit boards. Similarly, it could constitute one or more complete computers, or alternatively, it could constitute a component useful within a computing system.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include, but are not limited to, processors, controllers, chip set components, programmable logic arrays (PLA), memory chips, network chips, and the like.

Moreover, it should be appreciated that although example sizes/models/values/ ranges may have been given, the present invention is not limited to the same. As manufacturing techniques (e.g., photolithography) mature over time, it is expected that devices of smaller size could be manufactured. In addition, well known power/ground connections to IC chips and other components may or may not be shown within the Figures for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. A chip, comprising:
a traceback memory to store forward path information for received data symbols; and
a path memory coupled to the traceback memory to store trace-backed path information including state identifier and state value information to provide decoded bit data from the state value information.

2. The chip of claim 1, in which the traceback memory comprises at least an X rows by Y columns array of bit cells, where X is the number of different states used in a Viterbi encoding scheme and Y corresponds to a suitable number of cycles.

3. The chip of claim 2, in which the traceback memory comprises row and column selection circuits to select a particular bit cell for a read or write operation.

4. The chip of claim 3, comprising a column select circuit coupled between the traceback and path memories to provide linked column select pointers to the traceback and path memories.

5. The chip of claim 4, in which the linked pointers are to select corresponding columns in the traceback and path memories for a read operation in the traceback memory and a write operation in the path memory.

6. The chip of claim 5, comprising a second column select circuit coupled between the traceback and path memories to provide linked column select pointers to select a column in the traceback memory for a write operation and a column in the path memory offset at least one column ahead of the selected traceback memory column for a decode read operation in the path memory.

7. The chip of claim 4, in which the column select circuit comprises at least Y cascaded together flip flop circuits in a cyclical domino chain configuration to enable one column at a time in the traceback and path memories for at least one mode of operation.

8. The chip of claim 6, in which the linked pointers from the first named column select circuit move at a significantly faster rate than the linked pointers from the second column select circuit.

9. The chip of claim 1, in which the traceback memory contains only a single read port to read state data to be transferred to the path memory.

10. A chip, comprising:
a traceback memory to store forward path information for received data symbols in accordance with a Viterbi encoding scheme;
a path memory coupled to the traceback memory to store trace-backed path information including state identifier and state value information to provide decoded bit data; and
a traceback control circuit coupled to the traceback and path memories to control the reading of trace-backed state values from the traceback memory and the writing of the read state values and known state identifiers into the path memory.

11. The chip of claim 10, in which the traceback memory comprises at least an X rows by Y columns array of bit cells, where X is the number of different states used in the Viterbi encoding scheme and Y corresponds to a suitable number of cycles.

12. The chip of claim 11, in which the traceback memory comprises row and column selection circuits to select a particular bit cell for a read or write operation.

13. The chip of claim 12, comprising a column select circuit coupled between the traceback and path memories to provide linked column select pointers to the traceback and path memories.

14. The chip of claim 13, in which the linked pointers are to select corresponding columns in the traceback and path memories for a read operation in the traceback memory and a write operation in the path memory.

15. The chip of claim 14, comprising a second column select circuit coupled between the traceback and path memories to provide linked column select pointers to select a column in the traceback memory for a write operation and a column in the path memory offset at least one column ahead of the selected traceback memory column for a decode read operation in the path memory.

16. The chip of claim 14, in which the column select circuit comprises at least Y cascaded together flip flop circuits in a cyclical domino chain configuration to enable one column at a time in the traceback and path memories.

17. The chip of claim 15, in which the linked pointers from the first named column select circuit move at a faster rate than the linked pointers from the second column select circuit.

18. The chip of claim 17, in which the linked pointers from the first named column select circuit are to disable upon entry of a replay mode.

19. The chip of claim 10, in which the traceback memory contains only a single read port to read state data to be transferred to the path memory.

20. A computing device, comprising:
(a) a microprocessor;
(b) a wireless interface coupled to the microprocessor, the wireless interface comprising a receiver circuit with a Viterbi decoder having a traceback unit comprising:
(i) a traceback memory to store forward path information for received data symbols; and
(ii) a path memory coupled to the traceback memory to store trace-backed path information including state identifier and state value information to provide decoded bit data from the state value information; and
(c) an antenna coupled to the receiver to wirelessly link the wireless interface to a wireless network.
